(19) United States
(12) Patent Application Publication
(10) Pub. No.: US 2016/0034955 A1
(43) Pub. Date: Feb. 4, 2016

(54) SYSTEM AND METHOD OF SHARING INFORMATION IN AN ONLINE SOCIAL NETWORK

(71) Applicant: Crytek GmbH, Frankfurt am Main (DE)

(72) Inventor: Cevat Yerli, Frankfurt am Main (DE)

(73) Assignee: CRYTEK GMBH, Frankfurt am Main (DE)

(21) Appl. No.: 14/882,117

(22) Filed: Oct. 13, 2015

Related U.S. Application Data
(62) Division of application No. 13/572,312, filed on Aug. 10, 2012.
(60) Provisional application No. 61/522,374, filed on Aug. 11, 2011.

(51) Int. Cl. G06Q 30/02; G06Q 50/00

(52) U.S. Cl. CPC G06Q 30/0255; G06Q 30/0277; G06Q 50/01

(57) ABSTRACT

Sharing information in an online social network, comprising data mining by analyzing a first user profile and a plurality of other user profiles for finding shared interests among the users of said profiles; selecting from the found shared interests a set of shared interests; displaying at the graphical user interface of the first user the profile of at least one of the other users sharing said set of selected shared interests; and displaying at the graphical user interface a list of the shared interests from the selected set.

### CROSS-REFERENCES TO RELATED APPLICATIONS

This application is a division of application Ser. No. 13/572312, filed Aug. 10, 2012, which claims the benefit of Provisional Application No. 61/522374, filed Aug. 11, 2011, the disclosures of which are incorporated by reference herein in their entirety.

### FIELD

The present invention relates to a system and to a method of sharing information in an online social network.

### BACKGROUND

There are many known systems and methods of sharing information in an online social network. Such systems and methods can be used to present to a user (member) information about other users (members) of the social network and/or about upcoming events. Usually, when the user logs in to a social network, the latest information about other members, in particular about linked contacts (“friends” and “buddies”), will be displayed on the graphical user interface. There are also displayed recommendations for new contacts on the basis of interrelated links (the linked contacts of the users' friends and buddies).

U.S. Pre-Grant Publication No. 2005/0171799 describes a method and a system for seeding online social network contacts. The system automatically recommends to the user a set of seed contacts that the user may employ to invite to join their social network. The set of seed contacts may be harvested from the user's existing portal activities as well as other sources. In one example, the system analyzes portal activity, such as e-mail exchanges with the user and the like, to determine a frequency of contact with the user. Other sources may include e-mails, names within an address book of the user, names within an address book of another person, a buddy list, an instant messaging list, an activity, a mailing list, an online discussion group, a membership in a category, chat group, and the like.

Besides the communication between members of the network, it is often very important to effectively place advertisements to attract the user's interests. Advertisements (ads) in online community sites are therefore usually targeted towards a specific user, based on the profile data the user has entered into the database. However, static advertisements just serve a single main purpose—advertising only. Thus the user does not see a reason to take any notice at all and often gets annoyed by the presence of ads.

U.S. Pre-Grant Publication No. 2005/0171955 describes a system and a method which are directed towards enabling information filtering using measures of an affinity of a relationship between subscribers of an online portal system. The affinity of a relationship may be determined based, in part, on the tracking of various online behaviors of and between subscribers of the portal system. Any of a variety of behaviors may be tracked, including message communications between subscribers, participation in instant messaging groups, purchases, activities, categories, and so forth. Such behaviors may be employed to determine a level of trust (or affinity) between subscribers of the portal system. This affinity measurement may be used to filter various information, including product recommendations, ratings, polling queries, advertising, social network communications, personal ads, search results, and the like. Moreover, this affinity measurement may also be employed to perform message spam detection.

Other targeting advertisement methods and system are described, e.g., in U.S. Pre-Grant Publication No. 2008/0147501, U.S. Pre-Grant Publication No. 2008/0162260 or U.S. Pre-Grant Publication No. 2010/0070335.

U.S. Pre-Grant Publication No. 2009/0319914 describes a method and a system for advancing the relationship between participants in an on-line community. It is described that the nature of the relationship may be represented in a user interface (UI) by a visual element that shows the extent or depth of the relationship. Facets of the relationship may be used to facilitate interaction between participants (e.g., if two participants both like a particular band, then information relevant to the band may be shown as part of the UI when the participants interact with each other). The nature of the relationship may be determined or characterized based on commonality of activities, commonality of interests, the extent to which the participants have interacted with each other in the past, or other facts.

### SUMMARY

There is still a need to provide a method and a system of sharing information for encouraging a first user (e.g., member) of a social network to explicitly engage with an unconnected second user, and/or to engage with content he/she does not know yet. Accordingly, the present disclosure relates to a system and to a method of sharing information for encouraging a first user (e.g., member) of a social network to explicitly engage with an unconnected second user, i.e., with someone the first user does not know yet. The present invention also relates to a system and to a method of sharing information for encouraging the first user (member) to explicitly engage with content he/she does not know yet, such as an advertisement, product information, event information etc.

According to a first aspect there is provided a method of sharing information in an online social network, comprising data mining by analyzing a first user profile and a plurality of other user profiles for finding shared interests among the users of said profiles; selecting from the found shared interests a set of shared interests; displaying at the graphical user interface of the first user the profile of at least one of the other users sharing said set of selected shared interests; and displaying at the graphical user interface a list of the shared interests from the selected set.

Further to this and in correspondence with said method, there is provided a system of sharing information in an online social network, comprising processing means for data mining by analyzing a first user profile and a plurality of other user profiles for finding shared interests among the users of said profiles; selecting means for selecting from the found shared interests a set of shared interests; and displaying means for displaying at the graphical user interface of the first user the profile of at least one of the other users sharing said set of selected shared interests and for displaying at the graphical user interface a list of the shared interests from the selected set.

Thus, various embodiments promote new connection of users in online communities through their shared interests. The first user will be provided with profiles of potential new contacts who share the same interest, e.g., in sports, music, or the like.

In another aspect, the method comprises displaying at the graphical user interface of the first user a list of suggested activities to be chosen by the first user for contacting a user corresponding to at least one displayed user profile. Thus the first user can easily choose how to communicate with the new contact(s), e.g., by e-mail, chat, or the like.

In a further aspect, the method comprises selecting advertisement relating to said selected interests and displaying said advertisement at the graphical user interface of the first user. Thus advertisements are not only displayed based on the profile of a single user, but also employed to connect any number of given users by highlighting the interests that they have in common. The first user will also receive ads which directly correspond to the field of shared interest, e.g., an ad banner of a product which both users like.

According to another aspect, the data mining comprises at least one of analyzing of static data stored in the user profiles; analyzing of actual behavior of the first user and/or of the other users; and analyzing of input data entered by the first and/or by the other users.

According to a further aspect of the invention, selecting the set of shared data comprises selecting from the found shared interests only those interests which each are shared by a minimum number of users.

In another aspect, displaying the profile of at least one of the other users comprises displaying at first the profiles of those other users who share the most interests with the first user.

Disclosed embodiments give the user a reason to actually take notice of advertisements. The sheer amount of data inside a big community can be overwhelming for any user to sort through in order to find the right information and, more importantly, the right people to communicate with. The system connects users that have the same interests by highlighting the common interests they share.

### BRIEF DESCRIPTION OF THE DRAWINGS

Further features and advantages, as well as the structure and operation of various illustrative embodiments, are described in more detail below with reference to the accompanying schematic drawings, wherein:

FIG. 1 shows the graphical user interface of the first user displaying profiles of other users sharing the same interests and displaying a set or list of these shared interests;

FIG. 2 shows the graphical user interface of FIG. 1 wherein the first user has selected one item from the list of shared interests and the system has updated and ranked the profiles of the other users according to the selected item;

FIG. 3A shows a page in the profile settings of the logged-in user;

FIG. 3B shows a list of users that share interests with the logged-in user;

FIG. 4A shows a different page of the user's view;

FIG. 4B shows a list of the user's interests to be used for searching other users that share the same interests;

FIG. 5A shows a list of the user's interests to be used for comparing these interests with those of one other user;

FIG. 5B shows a result list of the comparison;

FIG. 6 illustrates the function of the system for comparing other users as a group, collecting their interests as one set of interests and comparing this set to a single user;

FIGS. 7A and 7B illustrate the function of the system for comparing a group of users with their collected interests to another group of users; and

FIG. 8 shows a resulting ranked list illustrating how much the users of the selected group share interest in certain content.

### DETAILED DESCRIPTION

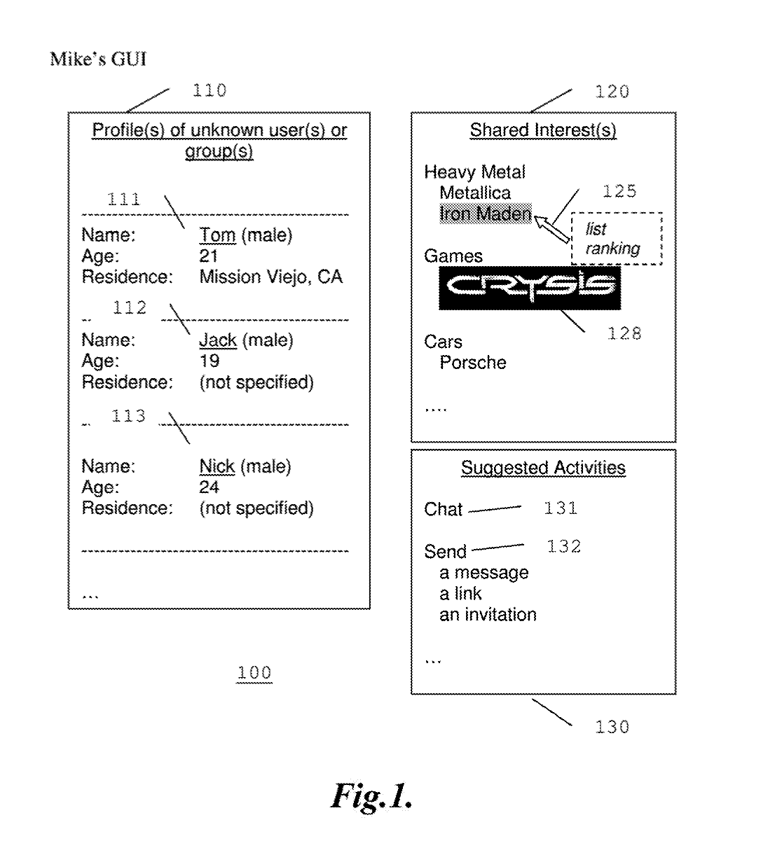

In FIG. 1 there is shown the graphical user interface (GUI) of a first user named “Mike” who is a member of an online social network. The system for managing the network may also perform methods of the present disclosure.

The system has a database containing user profile data which have been provided, e.g., by users via keyboard input or the like. Thus the system can analyze the profile data not only to manage log-ins, etc., but also for data mining in order to get information about shared interests among the users. The present disclosure proposes to create and use such data for suggesting to the user activities to get into contact with other users who are unknown to him/her. Further to this, the disclosure gives the user (in this example “Mike”) a reason to actually take notice of advertisements.

As shown in FIG. 1, the system displays on Mike's GUI 100 one or more profiles of users or groups who are not yet known by Mike. In a conventional system Mike would have to search for a profile of someone with whom he is not yet connected, finding the profile either by conducting a search for a term he is interested in (such as the PC game “Crysis,” the city of “Frankfurt,” or the car brand “Porsche”) or by browsing the lists of friends of his friends.

Embodiments of the present disclosure make Mike's life easier by automatically displaying at least one profile of an unknown user (e.g., “Tom”) who the system found to share some interests with Mike. Once the first user, “Mike,” has clicked on the profile of another user (e.g., “Tom”), the system shows him the shared interests that connect both users and offers options that let the first user contact that shown person. The system can display more than one profile as shown in FIG. 1. Thus the user Mike may see in a first window 110 a list of user profiles 111, 112, 113 relating to users Tom, Jack, and Nick who are yet unknown by Mike. In a second window 120, the system can show a list or set of shared interests, such as heavy metal music, PC games, and cars. In a third window 130, the system can suggest activities to the first user, such as entering a chat 131, sending 132 a message, a link, an invitation, or other data, as well as other suitable activities, which may be related to the first user and/or to one or more of the shared interests.

The advertisements 128 shown in the second window 120 will reflect the shared interests of all parties, forming a visceral connection between the parties. Thus the system is featured to create connections (e.g., friendship) between two or more users via interests, brands, and products.

In conventional systems, advertisements are seen mostly as annoying necessities because their purpose and use is controlled by others, not the user. But according to the present disclosure, advertisements are repurposed to demonstrate shared interests. Thus the user is in control of advertisements that are presented to him. Used in this way, advertisements are less intrusive to the user and may even be welcome.

The term “shared interest” describes any interest in specific content or activities that more than one user may have in common. The specific content or activities relating to content can be (but are not limited to) ads, videos, music, news, blogs, or events. Based on the available data of the user's interest, the shared data can range from the specific, such as a particular game (e.g., chess), to broad categories (e.g., automobiles).

The system uses different techniques of data mining to create the link between users. Sources of the data may include any of the following:
The static data stored in the profile of the user, which can serve as a demographic base.
The actual behavior of the user, e.g., where and when he accesses data.
Additional data about interests the user may have entered into his profile or that the system may have added based on his behavior.

Thus, both user-entered and system-collected data are used to filter the interests of two or more users that are shared with each other.

Described embodiments can provide for the display of the shared interest in various ways, e.g.:
The functionality of the shared interest can be used and integrated in an online community webpage as well as other similar applications. It can be displayed when the user is logged in and the system server knows who is actually using the device (PC, smartphone, or similar).
The shared interest can be displayed as a box next to the profile of the person the logged-in user has selected, showing his or her data (likely a short version of his or her profile) plus banner advertisements that both users share.
Lists of friends of another user that the logged-in user is browsing can also be sorted in this way, using the shared interest function to highlight the ones with which he has the most in common.

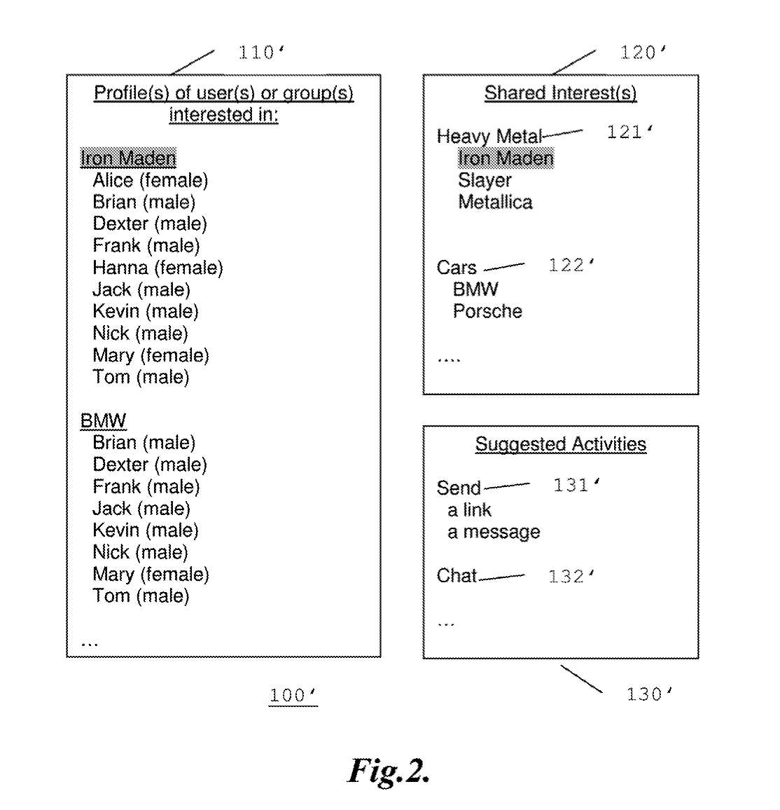

FIG. 2 shows another graphical user interface (GUI) 100′ of the first user, which may be displayed after the first user has selected one item from the list of shared interests of the GUI 100 as shown in FIG. 1 and after the system has updated and ranked the profiles of the other users according to the selected item. A first window 110′ of the GUI 100′ may show a list of profiles of users or groups interested in particular shared interests, such as heavy metal music, and cars. Similar to the second window 120 of FIG. 1, the GUI 100′ may also include a second window 120′ depicting a list or set of shared interests, such as heavy metal music 121′, cars 122′, and others. A third window 130′ may include a list of suggested activities related to the user and/or the shared interests, such as sending 131′ a link, a message, or any other suitable data, entering a chat 132′ with other users, and other suggested activities.

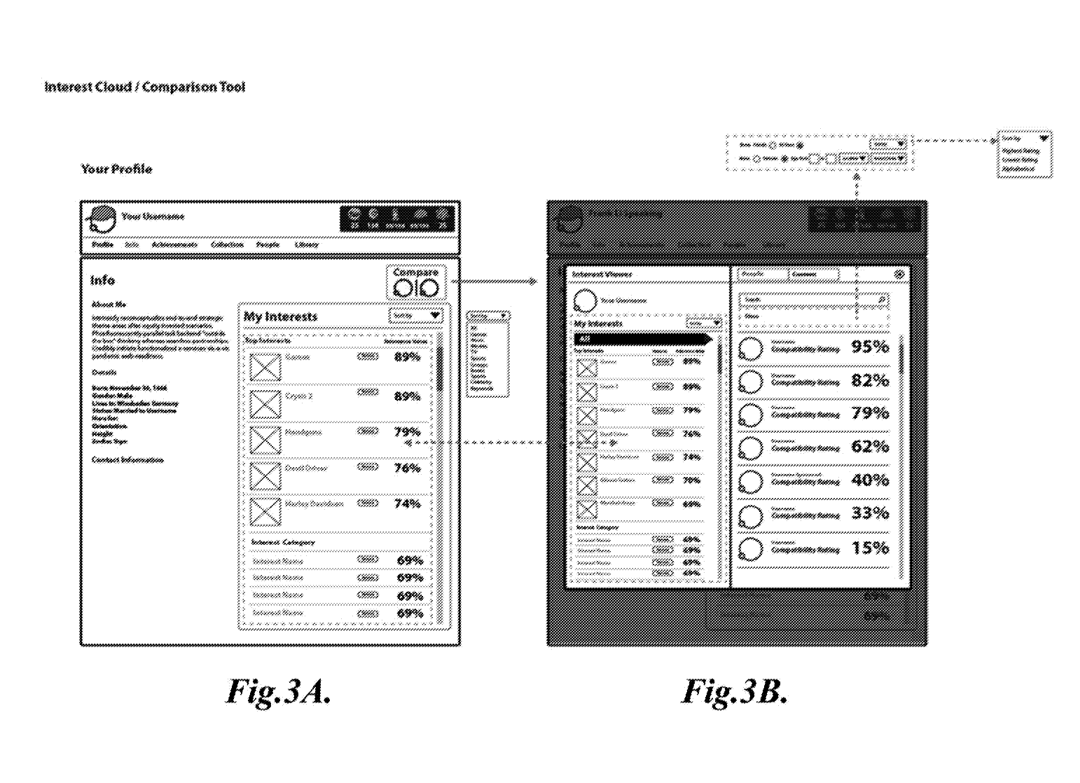

FIG. 3A shows a page in the profile settings of the logged-in user, including an interests list and their relevance to the logged-in user. With the “compare” button, the user can start a comparison of his interests with other users.

By searching the interest cloud of the social network, the system provides a list of users that share interests with the logged-in user (see “Interest Viewer” in FIG. 3B). In the right column is a list of other users and their rating of compatibility of the logged-in user's interest with the other users' interest. The list ranks the other users from highest rating to lowest rating. The ranking is based on the frequency and relevance of the interests for logged-in user and the compared users.

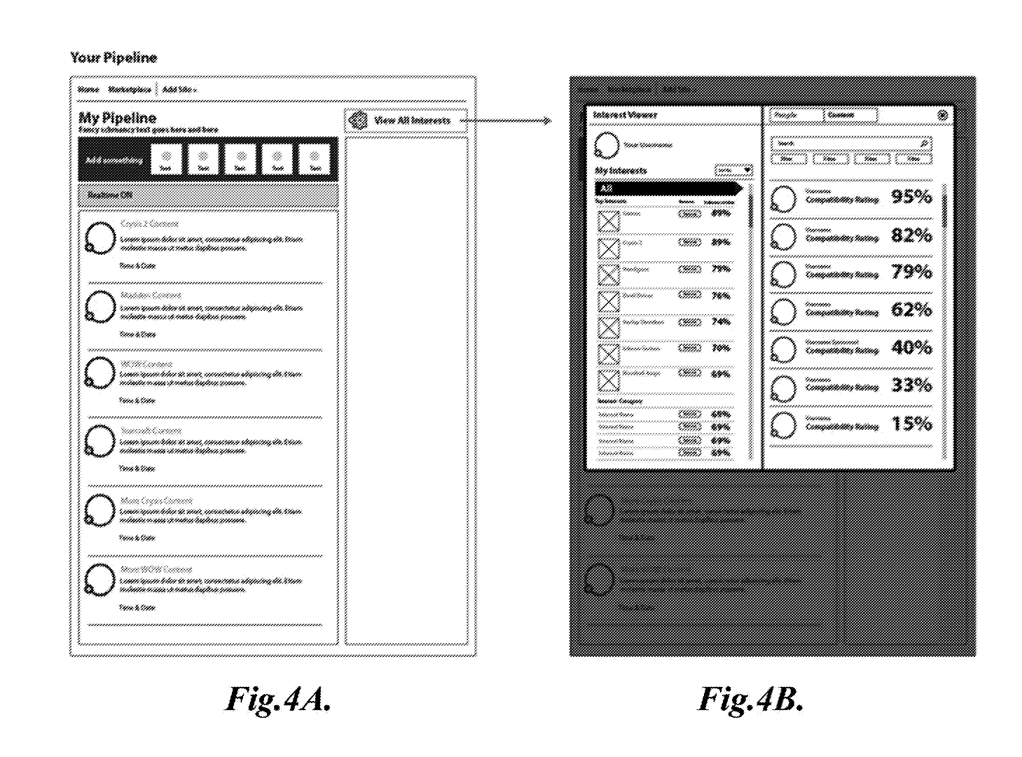

FIG. 4A shows a different page of the user's view of the social network, e.g., the pipeline of the user which shows various content.

By clicking a button (“view all interests” (see FIG. 4A)) the user can activate a function that lists his interests and searches for other users that share the same interests (see FIG. 4B).

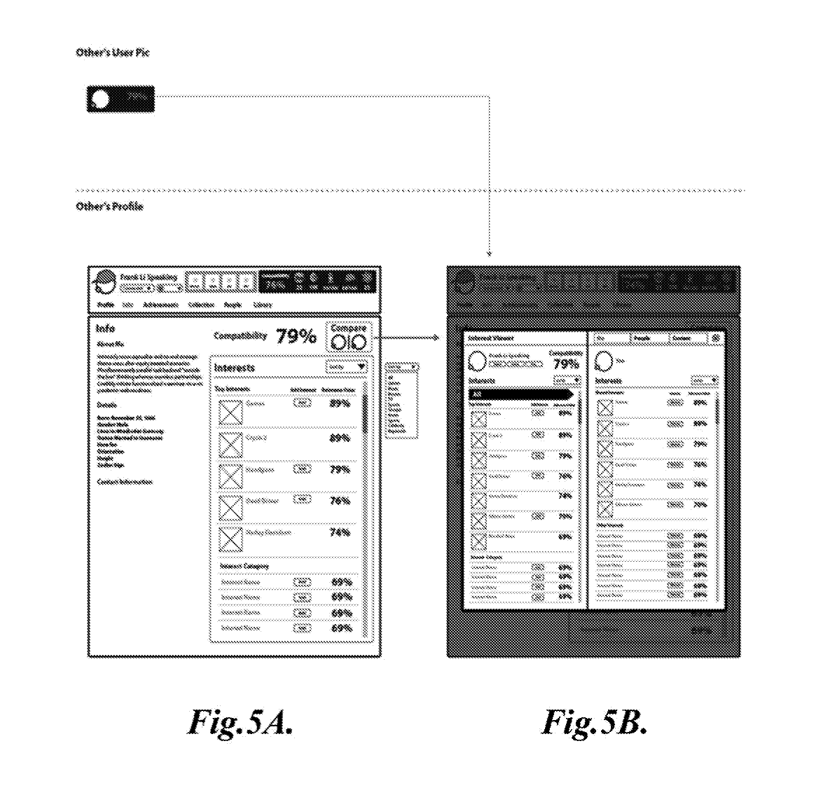

As shown in FIGS. 5A and 5B, the user can also compare his interests (FIG. 5A) directly with one other user, listing a detailed comparison ranked by the quality of the match-up (FIG. 5B).

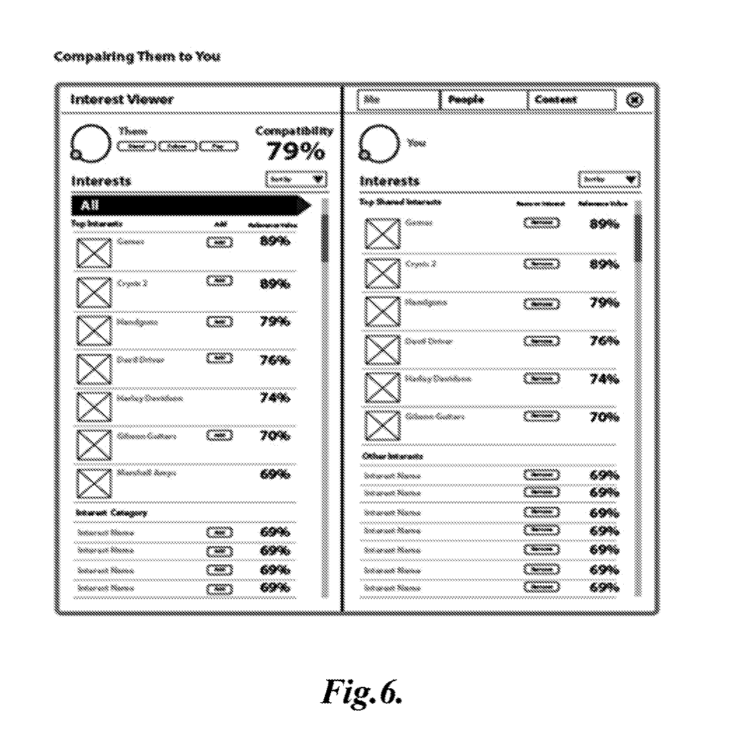

FIG. 6 illustrates that the system can compare other users as a group, collecting their interests as one set of interests and compare this set to a single user.

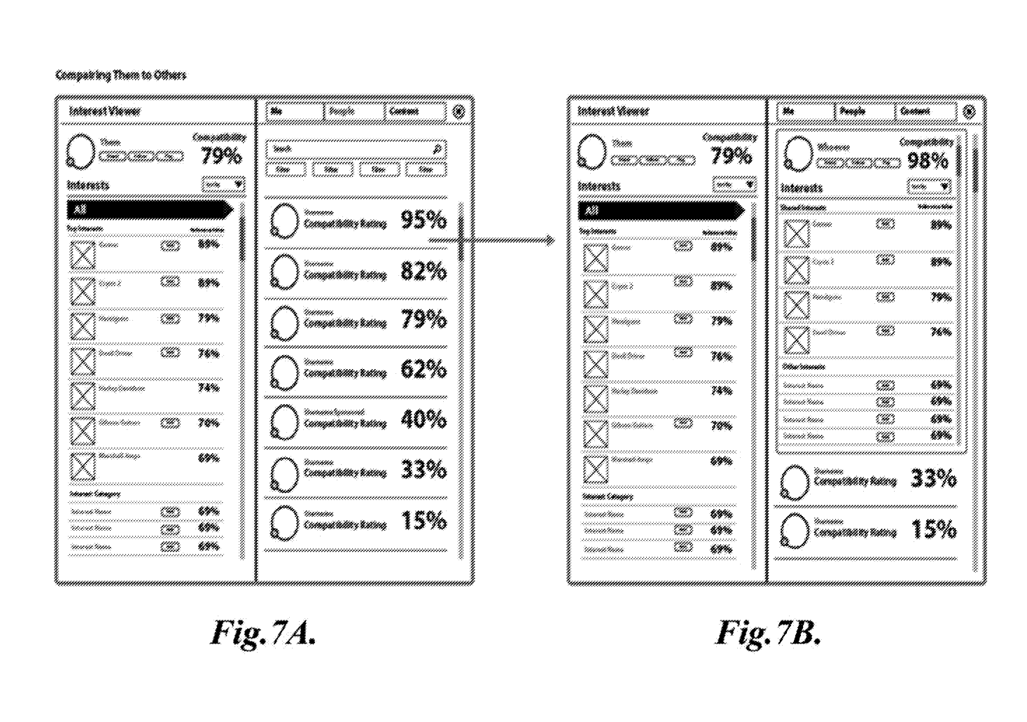

FIGS. 7A and 7B illustrate that the system can compare a group of users with their collected interest to another group of users with their collected interests, independent of the interests of the logged-in user.

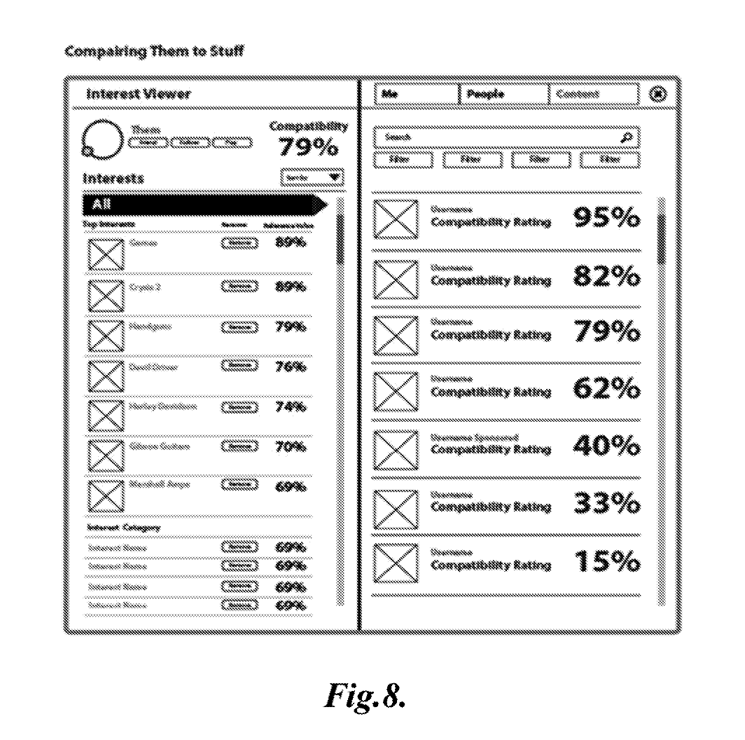

It is illustrated by FIG. 8 that the system stores users, as well as content, as items that are connected to other items. Therefore, a user is able to compare the interests of another user or a group of users to one or more items of content. The resulting ranked list shows the match-up of how much the users of the selected group share interest in certain content.

There are many use cases for the shared interest, such as the following:

(i) Watching Profiles of Other Users

A major use of the shared interest is to learn more about other users quickly and easily before contacting them. This is especially true when accessing a profile of an unknown user for the first time, either by being presented with the profile or accessing it directly. The shared interest is also a higher incentive to actually start a relationship with the unknown user as it is already based on positive expectations.

Example: The logged-in user is surfing through other users' profiles (see Table 1, below). In order to pull his attention to interests he really cares about, the advertisement next to the profiles of the different users is based upon the shared interests of both users.

(ii) Multiple Users and Interests

If more than one user matching the search criteria shares more than one interest with the logged-in user, the whole group is shown as such. With sufficient data, the aim is to connect users and to create groups that share the same interest(s). The system can suggest an action to get everyone in the group together.

Example: A user is surfing through user profiles of users unknown to him. Two users are displayed that both match his search terms and share his interests. As shown in

Table 2, below, two users share interest in the same online game as the logged-in user. To actually connect the users, an activity is suggested, in this case, playing a favorite game together.

(iii) Sort Friends' Lists by Shared Interest Ranking

Another way that the logged-in user can make connections is by browsing the lists of friends of any other user, whether an existing friend of his or someone that he has discovered by browsing (as above). The shared interest function can sort these users by the interests that they share with the logged-in user, placing those with the most in common at the top of the list and, again, highlighting these profiles with advertisements that reflect the interests that they share with the logged-in user. By using the ads as icons next to the user, the logged-in user has a fast overview of the displayed ranking of users.

(iv) Enhancing Interest by Presenting Other Users with Shared Interest

Example: A logged-in user is looking at content that is unknown to him (in other words, content that is not yet connected with his profile). Next to the content, the system displays unknown users that share interest in this specific content and, optionally, other interests with the logged-in user. This can convince the user positively to strengthen his interest in the new content, and through his interest in the new content connect him to new users via the shared interest.

(v) Strengthening the Relationship with Known Users

A logged-in user sees, upon visiting the profile of a friend (a known user), the updated list of shared interests, with the latest additions to the list on top. Thus, the logged-in user learns more about his friend. If the logged-in user selects now one of the interests of his friend, the system displays other users sharing the interest, and also suggests an activity with the other users based upon the latest shared interests.

(vi) Advertiser's Analysis

Example: An advertiser being logged-in as a normal user wants to compare the interests of several users or groups of users. The advertiser selects these users or groups, creating a temporary selection of users. The advertiser can now view the interests of this selection, and sort them by various means, e.g., highest ranked, most frequent interest among this selection. The advertiser can compare the similarities of shared interests among the users by selecting one or more interests and seeing how these overlap among the selected users. Thus, the system enables this user (advertiser) to compare the interests of the other user or group without the connection to his own interests.

TABLE 1

| User | User 1 | | User 2 | | User 3 | | User 4 | |
|---|---|---|---|---|---|---|---|---|
| Shared | Game 1 | 95% | Game 1 | 15% | Game 1 | 87% | Game 1 | 24% |
| Interests | News | 34% | News | 86% | News | 78% | News | 11% |
| | Racing Cars | 17% | Racing Cars | 67% | Racing Cars | 54% | Racing Cars | 7% |
| | Asian Food | 56% | Asian Food | 10% | Asian Food | 91% | Asian Food | 78% |

In Table 1, above, four users are combined to a selection. Their individual shared interests are compared and can give different results, depending on the query. As an example, four different interests are chosen that are shared in varying relevance by all four users. The comparison can show what interests are most important for that group.

Table 2, below, shows an example ranking of the most important interests in a group:

TABLE 2
Group Ranking

| | | |
|---|---|---|
| (1) | Asian Food | 40 |
| (2) | Game 1 | 29 |
| (3) | News | 25 |
| (4) | Racing Cars | 11 |

The present disclosure also provides a method to target advertisements toward a group of two or more users that:
(a) are yet unconnected (e.g., do not know each other yet) and to increase the chance to connect these users (stimulate a connection) by bringing the interest of the other users to the attention of the single user, and thus increase the value of the possible new connection to the other user; or
(b) are connected already, but have not yet realized the deeper link to the other users by offering knowledge about the shared interests between the users.

While illustrative embodiments have been illustrated and described, it will be appreciated that various changes can be made therein without departing from the spirit and scope of the claimed subject matter.

1-8. (canceled)

9. A method to target advertisements toward a group of two or more users, including a single user and other users, that are yet unconnected and to increase the chance to connect these users, the method including bringing the interest of the other users to the attention of the single user, and thus increase the value of a possible new connection to the other user.

10. The method of claim 9, wherein at least some of the users of the group are connected via a deeper link to the other users, the method further comprising offering knowledge about the shared interests between the users.

11. The method of claim 9, further comprising stimulating a connection between the two or more users.

12. The method of claim 9, wherein said bringing the interests of the other users to the attention of the single user includes:
data mining by analyzing a user profile of the single user and a plurality of other user profiles of the other users for finding shared interests among the users of said profiles;
selecting from the found shared interests a set of shared interests;
displaying at a graphical user interface of the single user the user profile of at least one of the other users sharing said set of selected shared interests; and
displaying at the graphical user interface a list of the shared interests from the selected set.

13. The method of claim 12, further comprising displaying at the graphical user interface of a second user, in particular of a second user who wants to advertise via a social network, a list of interests of at least one of the other users or a group of the other users, the list enabling the user to compare interests of the at least one other user or the group without connection to interests of the second user.

14. The method of claim 12, further comprising displaying at the graphical user interface of the single user a list of suggested activities to be chosen by the single user for contacting a user of at least one of the other displayed user profiles.

15. The method of claim 12, further comprising:
selecting an advertisement relating to said selected shared interests; and
displaying said advertisement at the graphical user interface of the single user.

16. The method of claim 12, wherein data mining comprises at least one of:
analyzing of static data stored in the user profiles;
analyzing of actual behavior of the single user and/or of the other users; and
analyzing of input data entered by the single user and/or by the other users.

17. The method of a claim 12, wherein selecting the set of shared data comprises selecting from the found shared interests only those interests which each are shared by a minimum number of users.

18. The method of claim 12, wherein displaying the profile of at least one of the other users comprises displaying at first the profiles of those other users who share the most interests with the single user.

19. A computer system for targeting advertisements toward a group of two or more users, including a single user and other users, that are yet unconnected and to increase the chance to connect these users, the system comprising one or more computing devices configured for:
bringing the interest of the other users to the attention of the single user, and thus increasing the value of a possible new connection to the other users.

20. The system of claim 19, wherein the interests of the other users are brought to the attention of the single user by sharing information in an online social network, the one or more computing devices being further configured for:
data mining by analyzing a user profile of the single user and a plurality of other user profiles of the other users for finding shared interests among the users of said profiles;
selecting from the found shared interests a set of shared interests;
displaying at a graphical user interface of the single user the user profile of at least one of the other users sharing said set of selected shared interests, and for displaying at the graphical user interface a list of the shared interests from the selected set.
